(19) United States
(12) Patent Application Publication
(10) Pub. No.: US 2010/0131272 A1
(43) Pub. Date: May 27, 2010

(54) APPARATUS AND METHOD FOR GENERATING AND VERIFYING A VOICE SIGNATURE OF A MESSAGE AND COMPUTER READABLE MEDIUM THEREOF

(75) Inventor: Jui-Ming WU, Yonghe City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, TAIPEI (TW)

(21) Appl. No.: 12/349,255

(22) Filed: Jan. 6, 2009

(30) Foreign Application Priority Data
Nov. 25, 2008 (TW) 097145542

(51) Int. Cl. G10L 15/06; G10L 17/00

(52) U.S. Cl. 704/243; 704/250; 704/E15.007; 704/E17.011

(57) ABSTRACT

Apparatuses and methods for generating and verifying a voice signature of a message and computer readable medium thereof are provided. The generation and verification ends both use the same set of pronounceable symbols. The set of pronounceable symbols comprises a plurality of pronounceable units, and each of the pronounceable units comprises an index and a pronounceable symbol. The generation end converts the message into a message digest by a hash function and generates a plurality of designated pronounceable symbols according to the message digest. A user utters the designated pronounceable symbols to generate the voice signature. After receiving the message and the voice signature, the verification end performs voice authentication to determine a user identity of the voice signature, performs speech recognition to determine the relation between the message and the voice signature, and determines whether the user generates the voice signature for the message.

This application claims the benefit of priority based on Taiwan Patent Application No. 097145542 filed on Nov. 25, 2008, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention related to apparatuses and methods for generating and verifying an electronic signature of a message and computer readable medium thereof. More particularly, the electronic signature of the present invention is a voice signature related to a voice of a user.

2. Descriptions of the Related Art

Over recent years, with the advent of the Internet era, business transactions conducted through the Internet have become increasingly prevalent and are expected to become the mainstream business means in the future. Unfortunately, the prevalence of Internet transactions has been accompanied by numerous cases involving fraud and data hijacking by hackers, e.g., false identification in the Internet transactions, unauthorized alteration of electronic information and fraud use of personal account numbers.

At present, a number of technologies for Internet transaction security have been commercially available, of which the most popular is the digital signature of the Public Key Infrastructure (PKI). According to the technology of this digital signature, cryptographic operations and digital authentication are conducted on the transaction information by using a pair of public key and secret key. However, when using this digital signature technology based on a pair of public key and secret key, users are still exposed to the risk of transaction insecurity, e.g., loss of the secret key.

The reason why the commercially available PKI digital signature technology still exposes the users to risk is that the PKI digital signature technology only establishes the relationship between the digital signature and the electronic message, and no relationship exists between the users and the secret key at all. Hence, when a secret key is stolen and is used to illegally generate a digital signature, it is difficult for the user to notice that the key has been stolen. Accordingly, it is important to strengthen the specific relationship between the user and the digital signature to enhance the security level.

### SUMMARY OF THE INVENTION

One objective of this invention is to provide a method for generating a voice signature of a message. This method is used in combination with a set of pronounceable symbols. The set of pronounceable symbols comprises a plurality of pronounceable units, each of the pronounceable units comprises an index and a pronounceable symbol. The method comprises the following steps: (a) converting the message into a message digest according to a hash function; (b) generating a plurality of designated pronounceable symbols of the message digest according to the set of pronounceable symbols, wherein each of the designated pronounceable symbols corresponds to one of the pronounceable symbols; (c) receiving a plurality of pronunciation acoustic waves, wherein each of the pronunciation acoustic waves is obtained from a user uttering one of the designated pronounceable symbols; (d) converting each of the pronunciation acoustic waves into a voice signal individually; and (e) generating the voice signature according to the voice signals.

Another objective of this invention is to provide a computer readable medium which stores a program for generating a voice signature of a message. The program is used in combination with a set of pronounceable symbols. The set of pronounceable symbols comprises a plurality of pronounceable units, each of which comprises an index and a pronounceable symbol. When loaded into a microprocessor and a plurality of codes thereof are executed, the program enables the microprocessor to execute the steps of the aforesaid method for generating the voice signature of a message.

Yet a further objective of this invention is to provide a method for verifying a voice signature of a message. This method is used with a voice database and a set of pronounceable symbols. The set of pronounceable symbols comprises a plurality of pronounceable units, each of the pronounceable units comprises an index and a pronounceable symbol. The method comprises the following steps: (a) authenticating that the voice signature belongs to a user by performing voice authentication on the voice signature according to the voice database (i.e. the speaker from whom the voice signature is derived is the user); (b) generating a plurality of recognition symbols by performing speech recognition on the voice signature according to the voice database, wherein each of the recognition symbols corresponds to one of the pronounceable symbols; (c) converting the message into a message digest according to a hash function, wherein the message digest comprises a plurality of bit strings and each of which corresponds to one of the indices; and (d) verifying that the user has generated the voice signature for the message by determining that the recognition symbols and the corresponding indices correspond to the same pronounceable units (i.e. the voice signature is generated by the user for the message).

Yet another objective of this invention is to provide a computer readable medium which stores a program for verifying a voice signature of a message. The program is used in combination with a voice database and a set of pronounceable symbols. The set of pronounceable symbols comprises a plurality of pronounceable units, each of which comprises an index and a pronounceable symbol. When loaded into a microprocessor and a plurality of codes thereof are executed, the program enables the microprocessor to execute the steps of the aforesaid method for verifying a voice signature of a message.

Still another objective of this invention is to provide an apparatus for generating a voice signature of a message. The apparatus comprises a storage module, a process module, and a receive module. The storage module is configured to store a set of pronounceable symbols. The set of pronounceable symbols comprises a plurality of pronounceable units, each of the pronounceable units comprises an index and a pronounceable symbol. The process module is configured to convert the message into a message digest according to a bash function and generate a plurality of designated pronounceable symbols of the message digest according to the set of pronounceable symbols, wherein each of the designated pronounceable symbols corresponds to one of the pronounceable symbols. The receive module is configured to receive a plurality of pronunciation acoustic waves, wherein each of the pronunciation acoustic waves is obtained from a user uttering one of the designated pronounceable symbols. The receive module is further configured to convert each of the pronunciation acoustic waves into a voice signal individually. The process module is further configured to generate the voice signature according to the voice signals.

Still a further objective of this invention is to provide an apparatus for verifying the voice signature of a message. The apparatus is used with a voice database. The apparatus comprises a storage module, a voice module, and a process module. The storage module is configured to store a set of pronounceable symbols The set of pronounceable symbols comprises a plurality of pronounceable units, each of the pronounceable units comprises an index and a pronounceable symbol. The voice module is configured to authenticate that the voice signature belongs to a user by performing voice authentication on the voice signature according to the voice database (i.e. the speaker from whom the voice signature is derived is the user). The voice module is further configured to generate a plurality of recognition symbols by performing speech recognition on the voice signature according to the voice database, wherein each of the recognition symbols corresponds to one of the pronounceable symbols. The process module is configured to convert the message into a message digest according to a hash function, wherein the message digest comprises a plurality of bit strings, each of the bit strings corresponds to one of the indices. The process module is further configured, to verify that the user has generated the voice signature for the message by determining that the recognition symbols and the corresponding indices correspond to the same pronounceable units (i.e. the voice signature is generated by the user for the message).

According to this invention, both the generation end and the verification end use the same set of pronounceable symbols and a message is converted into a message digest of a shorter length according to a hash function. The message digest comprises a plurality of bit strings and some of the pronounceable symbols are extracted from the set of pronounceable symbols according to the bit strings. Because the conversion performed by the hash function is approximately one-to-one, the converted message digest and the pronounceable symbols extracted therefrom are adequate to represent the message. Then, the generation end receives acoustic waves generated by the user uttering the extracted pronounceable symbols, converts each of the acoustic waves into a voice signal, and generates the voice signature according to the voice signals. According to the aforementioned description, a signature (i.e. a voice signature) of a message is generated by incorporating the unique biometric voice features of a user. This invention reduces the risk caused by the loss of the secret key of a conventional PKI digital signature.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a voice signature system according to a first embodiment;

FIG. 2 is a flowchart of a method for generating a voice signature of a message;

FIG. 3A is a flowchart of a pre-process for a user to register a voice;

FIG. 3B is a partial flowchart of a method for verifying a voice signature of a message;

FIG. 3C is a flowchart of a first alternative way for verification; and

FIG. 3D is a flowchart of a second alternative way for verification.

### DESCRIPTION OF THE PREFERRED EMBODIMENT

In the following description, this invention will be explained with reference to embodiments thereof. The description of this invention relates to a voice signature system capable of generating and then verifying the voice signature of a message. The voice signature generated in this invention is not only correlated with the message itself but also with the user, so the security is enhanced. However, these embodiments are not limited to any specific environment, applications, or implementations. Therefore, the descriptions of the following embodiments are only for purposes of illustration rather than limitation.

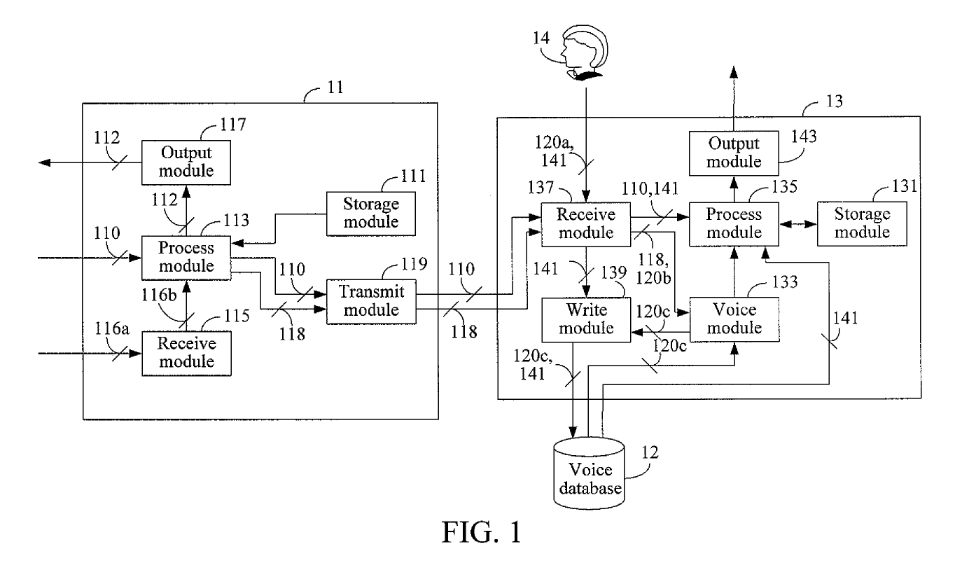

FIG. 1 depicts a first embodiment of this invention, which is a voice signature system. The voice signature system comprises an apparatus for generating a voice signature of a message (hereinafter referred to as a generation apparatus 11) and an apparatus for verifying a voice signature of a message (hereinafter referred to as a verification apparatus 13). The generation apparatus 11 and the verification apparatus 13 must be used with each other. The generation apparatus 11 and the verification apparatus 13 have to respectively adopt a generation method and a verification method which correspond to each other. Furthermore, both the generation apparatus 11 and the verification apparatus 13 work with the same set of pronounceable symbols.

In particular, the generation apparatus 11 comprises a storage module 111, a process module 113, a receive module 115, an output module 117, and a transmit module 119. The verification apparatus 13 comprises a storage module 131, a voice module 133, a process module 135, a receive module 137, a write module 139, and an output module 143. Additionally, the verification apparatus 13 is connected to a voice database 12 for use in combination therewith.

The storage module 111 of the generation apparatus 11 is configured to store a set of pronounceable symbols as listed in Table 1. Likewise, the storage module 131 of the verification apparatus 13 is also configured to store this set of pronounceable symbols. The set of pronounceable symbols comprises a plurality of pronounceable units, wherein each of the pronounceable units comprises an index and a pronounceable symbol. The pronounceable symbols are symbols that can be easily pronounced when a user saw it, and each of the pronounceable symbols has a different pronunciation. Table 1 shows that the set of pronounceable symbols used in the first embodiment comprises 32 pronounceable units, in which each index consists of 5 bits and each pronounceable symbol is a letter or numeral. It should be emphasized that in other embodiments, the set of pronounceable symbols may be presented in other forms than a table (e.g. in form of a regular list), there may be more bits in each index, and the indices may be expressed in other forms than the binary form. Furthermore, in other embodiments, the pronounceable symbols may be other characters, images and symbols, etc., provided that the user knows how to easily pronounce the pronounceable symbols and each symbol has a different pronunciation. The invention can provide different sets of pronounceable symbols according to the user's choice.

TABLE 1

| | Pronounceable |
|---|---|
| Index | symbol |
| 00000 | A |
| 00001 | B |
| 00010 | C |
| 00011 | D |
| 00100 | E |
| 00101 | F |
| 00110 | G |
| 00111 | H |
| 01000 | I |
| 01001 | J |
| 01010 | K |
| 01011 | L |
| 01100 | M |
| 01101 | N |
| 01110 | O |
| 01111 | P |
| 10000 | Q |
| 10001 | R |
| 10010 | S |
| 10011 | T |
| 10100 | U |
| 10101 | V |
| 10110 | W |
| 10111 | X |
| 11000 | Y |
| 11001 | Z |
| 11010 | 2 |
| 11011 | 3 |
| 11100 | 4 |
| 11101 | 5 |
| 11110 | 6 |
| 11111 | 7 |

In this embodiment, the storage module 131 of the verification apparatus 13 may have a plurality of suitable sets of pronounceable symbols pre-stored therein for the user's choice. The user 14 may choose a set of pronounceable symbols for use via the verification apparatus 13 during a registration pre-process to be described later. In particular, the receive module 137 of the verification apparatus 13 receives a set identity 141 chosen by the user and stores the set identity 141 into the voice database 12 via the write module 139. Because each suitable set of the pronounceable symbols stored in the storage module 131 has an identity, the process module 135 may choose the aforesaid set of pronounceable symbols (Table 1) from these suitable sets according to the set identity 141, wherein the identity of the chosen set is identical to the set identity. The generation apparatus 11 may obtain the same set of the pronounceable symbols from the verification apparatus 13. The way in which this apparatus is setup is not intended to limit scope of this invention. Therefore, the user 14 may choose the desired set of pronounceable symbols. In case there are a number of users who are using this voice signature system, different users 14 may use different sets of pronounceable symbols.

It should be appreciated that in other embodiments, a set of pronounceable symbols may be defined to be used by different users 14 and pre-stored in the storage module 111 of the generation apparatus 11 and the storage module 131 of the verification module 13. In this case, it is not necessary for the users 14 to choose a set identiy141, nor is it necessary for the write module 139 to store the set identity 141 into the voice database 12.

Before describing how the voice signature of a message is generated and verified, some pre-processes will be described first. Initially, the user 14 will perform a voice registration to establish his or her voice reference in the voice database 12 in advance for use in subsequent verification of the voice signature, which is done via the verification apparatus 13. In particular, the output module 143 outputs pronounceable symbols contained in the set of pronounceable symbols. Afterwards, the user 14 utters each of the pronounceable symbols in the set to individually generate a registered acoustic wave 120a. The receive module 137 receives these acoustic waves 120a and further converts each of them into a voice signal 120b. Then the voice module 133 receives these voice signals 120b and performs relevant voice processing such as voice feature extraction and acoustic modeling to generate the voice reference 120c of the user 14. The methods in which the voice module 133 performs the aforesaid voice processing to generate the voice reference 120c will be appreciated by those of ordinary skill in the art and, thus, will not be detailed herein. Thereafter, the write module 139 receives and stores the voice reference 120c into the voice database 12. Also, the write module 139 stores an identity of the user 14 corresponding to his voice reference 120c and the set identity 141.

It should be appreciated that in other examples, the aforesaid pre-processes performed by the receive module 137, the voice module 133, and the write module 139 may be accomplished by other devices. In this case, the disposition of the write module 139 may be eliminated in the verification apparatus 13, and it is unnecessary for the voice module 133 and the receive module 137 of the verification apparatus 13 to perform the aforesaid operations.

Next, how the generation apparatus 11 generates a voice signature of a message 110 will be described. The process module 113 of the generation apparatus 11 converts the message 110 into a message digest according to a hash function. The purpose of converting the message according to the hash function is to convert the message 110 of a longer length into a message digest of a shorter length because a shorter length will render subsequent processing more efficient. As can be appreciated by those of ordinary skill in the art, the inherent nature of the hash function determines that the probability for different messages to be converted into the same message digest is very low, so the hash function is usually considered to provide a one-to-one conversion. The one-to-one conversion provided by the hash function means that the converted the message digest is adequate enough to represent the original unconverted message.

Furthermore, the hash function used by the process module 113 may be SHA-1, MD5, DES-CBC-MAC, or any other hash function algorithms with similar functionalities. In addition, the process module 113 may also use a keyed hash function such as the RFC 2104 HMAC algorithm. If a keyed hash function is used, the process module 113 will convert the message 110 into the message digest according to the keyed hash function and a preset key possessed by the user 14. How the keyed hash function works with the preset key is well known to those of ordinary skill in the art and, thus, will not be further described herein. The keyed hash function is advantageous in that it can prevent other people from forging the voice signature by skimming. Hence, an attacker who has no knowledge of the preset key of the user 14 will fail to make up the correct voice signature from voice data of the user skimmed in the past.

No matter whether a simpler hash function or a more complex keyed hash function is used, the process module 113 may use the function in combination with the following technology to prevent fraud transactions by the attacker through replay attack (i.e. repeated use of the voice signature previously obtained).

Additionally, the process module 113 may add a random number and/or a time message into the message 110 before converting the message 110 into the message digest according to the hash function. In this way, conversions of the same message at different time points will generate different message digests. It should be noted that the random number and/or the time message to be used by the process module 113 of the generation apparatus 11 and the random number and/or the time message used by the verification apparatus 13 at a later time has the same value(s). For example, before a voice signature is generated, the verification apparatus 13 generates a random number on a random basis and transmits it to the generation apparatus 11. This enables the random numbers and/or time messages used by the generation apparatus 11 and the verification apparatus 13 to be identical. In some examples, the process module 113 may also add a random number and/or a time message into the message digest after the message 110 is converted into the message digest, which also allows conversions of the same message at different time points to generate different message digests. By adding a random number and/or a time message, fraud transactions by the attacker through replay attack can be prevented.

After converting the message 110 into the message digest, the process module 113 generates a plurality of designated pronounceable symbols 112 of the message digest by using the set of pronounceable symbols, in which each of the designated pronounceable symbols 112 corresponds to one of those pronounceable symbols in the set. For example, the process module 113 may divide the message digest into a plurality of bit strings, and compare each of the bit strings to the indices in the set of the pronounceable symbols to extract a corresponding designated pronounceable symbol 112. The message digest may bee divided according to the number of bits of an index in the set of pronounceable symbols, and each resulting bit string has an equal number of bits. In particular, each index in the set of pronounceable symbols shown in Table 1 is represented by five bits, so the process module 113 divides the message digest into bit strings in unit of five bits. In this case, it is preferred that each resulting bit string has 5 bits, i.e., the number of bits in the original bit string is a multiple of 5. For example, if the original bit string is 000001011110110, the resulting bit strings will be 00000, 10111 and 10110.

Furthermore, the resulting bit strings obtained by dividing the message digest are arranged in a specific order. Upon completion of the division, the process module 113 determines whether the number of bits in the last bit string is equal to a preset bit number. If it is not equal, the process module 113 pads the last bit string to the preset bit number with a preset bit. For example, if the message digest is divided into a unit of five bits, it is likely that only four bits remain in the last bit string. In this case, the process module 113 pads the last bit string with a preset bit (e.g. 0 or 1) to obtain a full five-bit length.

The process module 113 compares each of the bit strings against the indices of the set to extract a designated pronounceable symbol 112 individually. Also, taking the aforesaid bit strings 00000, 10111 and 10110 as an example, the process module 113 compares the bit string 00000 to the indices and the process module 113 extracts the pronounceable symbol A as a designed pronounceable symbol because the pronounceable symbol A corresponds to 00000. The process module 113 also compares the bit string 10111 with the indices and extracts the pronounceable symbol X as a designed pronounceable symbol because the pronounceable symbol X corresponds to 10111. Similarly, the process module 113 compares the bit string 10110 with the indices to extract the pronounceable symbol W as a designed pronounceable symbol because the pronounceable W corresponds to 10110.

It should be appreciated that, deriving the designated pronounceable symbols of the message digest from the set of pronounceable symbols is a requisite for the voice signature generation process. In other embodiments, methods that can derive the designated pronounceable symbols of the message digest in a nearly one-to-one fashion may also be used.

Afterwards, the output module 117 outputs the designated pronounceable symbols 112, e.g., A, X, W described above. The output module 117 may present the designated pronounceable symbols 112 on a display, print them on a piece of paper or play them back from a loudspeaker. The specific ways for outputting the designated pronounceable symbols 112 are not intended to limit the scope of this invention. The user 14 can be informed of the designated pronounceable symbols 112 via the output module 117,

Then, the user 14 utters each of the designated pronounceable symbols 112 to generate a pronunciation acoustic wave 116a in the air respectively. Each of these pronunciation acoustic waves 116a is received and converted by the receive module 115 into a voice signal 116b. For example, the receive module 115 may be a microphone, to which the user 14 utters A, X, W so that the receive module 115 receives the corresponding pronunciation acoustic waves 116a thereof and converts them into corresponding voice signals 116b.

Thereafter, the process module 113 generates a voice signature 118 from the voice signal 116b. The process module 113 may generate the voice signature 118 in two different optional ways. The first way is to assemble the voice signals 116b into the voice signature 118. For example, the process module 113 may generates the voice signature 118 by concatenating the voice signals 116b. The second way is to extract a voice feature from each of the voice signals 116b and assemble the voice features into the voice signature 118. For example, the process module 113 extracts the voice feature from each of the voice signals 116b corresponding to A, X, W, and generates the voice signature 118 by concatenating the voice features of A, X, W. It is the voice signature 118 that the user 14 uses the generation apparatus 11 to generate for the message 110.

Finally, the transmit module 119 transmits the message 110 and the voice signature 118 to the verification apparatus 13.

Next, how the verification apparatus 13 verifies the message 110 and the voice signature 118 received will be explained. The receive module 137 of the verification apparatus 13 receives the message 110 and the voice signature 118 from the transmit module 119. Then, the verification apparatus 13 must authenticate the user's identity of the voice signature 118, i.e., authenticate who (i.e. the user 14) has generated the voice signature 118. Furthermore, the verification apparatus 13 must verify whether the relationship between the voice signature 118 and the message 110 is correct or not. If the verification apparatus 13 successfully authenticates the user identity of the voice signature 118, and ascertains that the relationship between the voice signature 118 and the message 110 is correct, then the overall process of signature verification is said to be successful, i.e., it is ascertained that the voice signature 118 is generated by the authenticated user (i.e. the user 14) for the message 110. Otherwise, if the verification apparatus 13 fails to authenticate the user identity of the voice signature 118 or fails to determine that the voice signature 118 corresponds to the message 110, then the verification fails. Detailed operations will be described later

As described above, the voice database 12 has stored the voice reference of the user 14 that has been created during the previous registration process. In addition, the voice database 12 may also contain voice references of other users. The content of the voice database 12 will be used in subsequent operations of the verification apparatus 13.

The detailed operations of the verification apparatus 13 will now be described. The voice module 133 authenticates that the voice signature belongs to a user by performing voice authentication on the voice signature 118 according to the voice references stored in the voice database 12. It is to determine if the voice signature 118 belongs to a user who has created his own voice reference in the voice database 12 (i.e. authenticate a user identity of the voice signature 118).

As described above, the process module 113 of the generation apparatus 11 may generate the voice signature 118 in two different ways. If the process module 113 of the generation apparatus 11 has generated the voice signature 118 by assembling (concatenating) the voice signals 116b, then at this point the voice module 133 extracts a plurality of voice features from the voice signature 118 first. Then, the voice module 133 compares the voice features to each of the voice references stored in the voice database 12 for similarity matching. On the other hand, if the process module 113 of the generation apparatus 11 has generated the voice signature 118 by assembling (concatenating) the voice features of the voice signals 116b, then at this point the voice module 133 retrieves the voice features directly from the voice signature 118 to compare to each of the voice references stored in the voice database 12 for similarity matching. If there is a similarity greater than a preset level, then the identity of the corresponding voice reference is determined as the user identity of the voice signature 118. Otherwise, if the voice module 133 determines that all similarities are smaller than the preset level, then the verification fails. It should be noted that the voice module 133 employs a conventional voice authentication approach to recognize the user identity of the voice signature 118, which is well known to those of ordinary skill in the art and thus will not be further described herein.

If the voice signature 118 is not corrupted during the transmission process, the voice module 133 will be able to tell that the voice signature 118 belongs to the user 14. Otherwise, if the voice signature 118 is corrupted, the voice module 133 will fail to distinguish the user identity of the voice signature 118. Additionally, if the voice signature is generated by an unregistered user, the voice module 133 will also fail to verify the identity.

Once the user identity of the voice signature 118 is determined, the voice module 133 further generates a plurality of recognition symbols by performing speech recognition on the voice signature 118 with according to the voice database 12. Assuming that the voice module 133 has successfully determined that the voice signature 118 belongs to the user 14, the voice module 133 will perform the speech recognition in two scenarios as described in the followings. If the process module 113 of the generation apparatus 11 has generated the voice signature 118 by assembling (concatenating) the voice signals 116b, then at this point, the voice module 133 uses the voice features previously extracted from the voice signature 118 to compare with the voice reference of the user 14 for recognition purposes, with the expectation of generating a plurality of recognition symbols. If no recognition symbol is recognized, the recognition fails. On the other hand, if the process module 113 of the generation apparatus 11 has generated the voice signature 118 by assembling (concatenating) the voice features of the voice signals 116b, then at this point, the voice module 133 uses the voice features in the voice signature 118 directly to compare with the voice reference of the user 14 for recognition purposes, with the expectation of generating a plurality of recognition symbols. If no recognition symbol is recognized, the recognition fails. It should be noted that the voice module 133 employs a conventional speech recognition approach to recognize the content of the voice, which is well known to those of ordinary skill in the art and thus will not be further described herein.

Here, it is assumed that the voice module 133 has successfully recognized the speech, i.e., the voice module 133 has recognized a plurality of recognition symbols 130 and each of the recognition symbols 130 corresponds to one of the pronounceable symbols in the set of pronounceable symbols individually. Continuing with the example used in the description of the generation apparatus 11, the recognition symbols 130 recognized by the voice module 133 here are A, X, W.

In other embodiments, the voice module 133 may also perform the speech recognition on the voice signature 118 prior to the voice authentication. It should be emphasized that, if the voice authentication performed by the voice module 133 fails (i.e. it fails to determine to which registered user the voice signature 118 belongs) or the speech recognition performed by the voice module 133 fails (i.e. it fails to recognize the recognition symbols), it means that the verification result of the verification apparatus 13 is unsuccessful and it is unnecessary to proceed with other operations. Additionally, even if the voice module 133 has successfully performed the voice authentication and recognized the recognition symbols 130, it is does not mean that the verification is already successful, and subsequent operations still have to be performed by the verification apparatus 13.

On the other hand, the process module 135 converts the message 110 into a message digest according to a hash function. For example, the converted message digest is 000001011110110. It should be emphasized that the process module 135 of the verification apparatus 13 must use the same hash function and perform the conversion in the same way as the process module 113 of the generation apparatus 11. Only in this way will the message digest generated by the process module 135 be identical to that generated by the process module 113 when the message 110 remains unaltered during transmission. Next, according to the user identity recognized by the voice module 133, the process module 135 retrieves the set identity 141 from the voice database 12 chosen by the user 14. The set identity 141 corresponds to a designated set of pronounceable symbols. According to the designated set of pronounceable symbols, the message digest (i.e. 000001011110110) generated by the process module 135 comprises a plurality of bit strings (i.e. 00000, 10111, 10110). The bit strings are set according to the bit number of each of the indices of the set of pronounceable symbols; that is, every five bits form a bit string. Each of the bit strings corresponds to one of the indices in the set of pronounceable symbols. By determining whether the recognition symbols 130 generated by the voice module 133 and the indices corresponding to these bit strings correspond to the same pronounceable units, the process module 135 is able to verify if the voice signature 118 is generated by the user 14 for the message 110. If the recognition symbols 130 and the indices corresponding to these bit strings correspond to the same pronounceable units, this means that the voice signature 118 is indeed generated by the user 14 for the message 110. In particular, the recognitions symbols 130 are A, X, W and the bit strings are 00000, 10111, 10110. Because A and 00000 belong to the same pronounceable unit, X and 10111 belong to the same pronounceable unit, and W and 10110 belong to the same pronounceable unit, the process module 135 determines that the voice signature 118 is indeed generated by the user 14 for the message 110. It is noted that the verification process will fail as long as one of the recognition symbols and the index corresponding to the corresponding bit string do not belong to the same pronounceable unit.

For the verification described above, the process module 135 may also follow two different alternative ways for verification as follows.

The first alternative way for verification is now described. The process module 135 performs further processing on the message digest. In particular, according to the set of pronounceable symbols, the process module 135 generates a plurality of designated pronounceable symbols of the message digest, each of which corresponds to one of the pronounceable symbols in the set. Because the generation apparatus 11 has done this by dividing the message digest the process module 135 of the verification apparatus 13 accomplishes this in the same manner. In other words, the process module 135 divides the message digest into a plurality of bit strings, which is accomplished in the same manner as the process module 113 of the generation apparatus 11 and thus will not be further described herein. Likewise, the resulting bit strings are arranged in a specific order. When the process module 135 determines that the number of bits in the last bit string is smaller than a preset bit number, it pads the last bit string to the preset bit number with a preset bit. Herein, it is assumed that the message 110 received by the verification apparatus 13 is not corrupted, so the bit strings generated by the process module 135 by dividing the message digest will be identical to those generated by the generation apparatus 11, i.e., 00000, 10111 and 10110. Then the process module 135 compares each of the bit strings to the indices of the set of pronounceable symbols to generate a designated pronounceable symbol. Because the bit strings are 00000, 10111, and 10110, the designated pronounceable symbols generated are A, X and W. Finally, the process module 135 sequentially compares the designated pronounceable symbols to the recognition symbols 130. Since both the designated pronounceable symbols and the recognition symbols 130 are A, X and W, the process module 135 determines that the verification result is positive, i.e., the voice signature 118 is indeed generated by the user 14 for the message 110.

Next, the second alternative way for verification is now described. The process module 135 compares each of the recognition symbols 130 recognized by the voice module 133 to the pronounceable symbols in the set of pronounceable symbols to extract a corresponding index individually. Since the recognition symbols 130 are A, X, and W, the extracted indices are 00000, 10111, and 10110 respectively. Then, the process module 135 concatenates the extracted indices into a recognition bit string, which is 000001011110110. Thereafter, the process module 135 compares the recognition bit string against the aforesaid bit string. Here, both of them are 000001011110110, so the process module 135 determines that the verification result is positive, i.e., the voice signature 118 is indeed generated by the user 14 for the message 110. In this verification method, if the recognition bit string has a length longer than that of the bit string, the extra bits were padded by the process module 113 and shall be discarded during the comparison.

Thus, three different ways have been described for verifying whether the voice signature 118 is generated by the user 14 for the message 110 according to the recognition symbols 130 recognized by the voice module 133 and the indices corresponding to the bit string. It should be appreciated that, the process module 135 of the verification apparatus 13 may use only one of the three ways for verification.

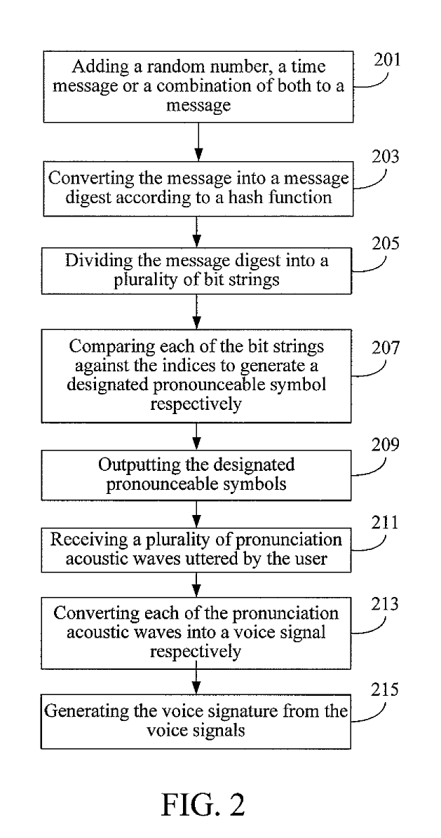

A second embodiment of this invention is a method for generating a voice signature of a message, a flowchart of which is depicted in FIG. 2. The method of the second embodiment is used in combination with a set of pronounceable symbols. The set of pronounceable symbols comprises a plurality of pronounceable units, each of which comprises an index and a pronounceable symbol. For example, the second embodiment may also use Table 1 as the set of pronounceable symbols.

The method of the second embodiment begins with step 201, where a random number, a time message or a combination of both is added to the message to be voice signed. It should be appreciated that, step 201 may be optionally eliminated in other examples. Next, step 203 is executed to convert the message into a message digest according to a hash function. Various hash functions may be used in step 203, such as SHA-1, MD5, DES-CBC-MAC, or any other hash function algorithms with similar functionalities. In addition, conversion in step 203 may also use a keyed hash function and a preset key, such as the RFC 2104 HMAC algorithm, which may make the method of the second embodiment more secure. The main purpose of step 203 is to convert a message of a longer length into a message digest of a shorter length.

Next, step 205 is executed to divide the message digest into a plurality of bit strings which are arranged in a specific order. The following description assumes that three bit strings are obtained herein, i.e., 00000, 10111, and 10110 respectively. During the dividing process of step 205, it is determined whether the number of bits in the last bit string is smaller than a preset bit number (e.g. the preset bit number is 5). If the number of bits in the last bit string is smaller than the preset bit number, the last bit string is padded to the preset bit number with a preset bit. Then, the method of the second embodiment proceeds to step 207 where each of the bit strings is compared to the indices in the set of pronounceable symbols to extract a corresponding designated pronounceable symbol individually. In particular, by comparing each of the three bit strings (i.e. 00000, 10111 and 10110) to the indices in the set of pronounceable symbols, the pronounceable symbols A, X, W are extracted. In other examples, steps 205 and 207 may be replaced by other operations to generate designated pronounceable symbols of the message digest according to the set of pronounceable symbols, so long as the designated pronounceable symbols are generated in a one-to-one correspondence.

Thereafter, step 209 is executed to output the designated pronounceable symbols (i.e. A, X, W). Thus, the user can utter each of the extracted designated pronounceable symbols to form a pronunciation acoustic wave individually. As a result, each of the pronunciation acoustic waves uttered by the user corresponds to one of the designated pronounceable symbols. Afterwards, the method of the second embodiment proceeds to step 211 to receive the plurality of pronunciation acoustic waves uttered by the user. Then, step 213 is executed to convert each of the pronunciation acoustic waves into a voice signal. Finally, step 215 is executed to generate the voice signature from the voice signals. In particular, step 215 may generate the voice signature in two different ways. The first way is to assemble (e.g. concatenate) the voice signals into the voice signature, while the second way is to extract a voice feature from each of the voice signals and then assemble (e.g. concatenate) the voice signals into the voice signature.

In addition to the aforementioned steps and functions, the second embodiment can also execute all the operations and accomplish all the functions of the generation apparatus 11 described in the first embodiment. The method in which the second embodiment executes these operations and accomplishes these functions will be readily appreciated by those of ordinary skill in the art based on the explanation of the generation apparatus 11 of the first embodiment, and thus will not be further described herein.

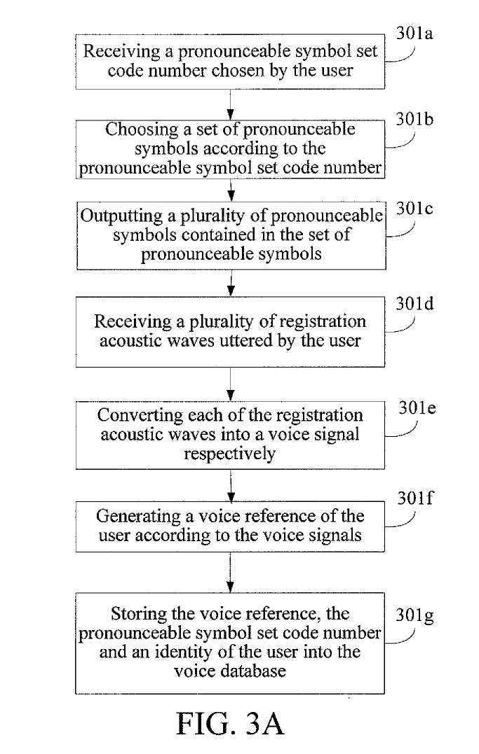

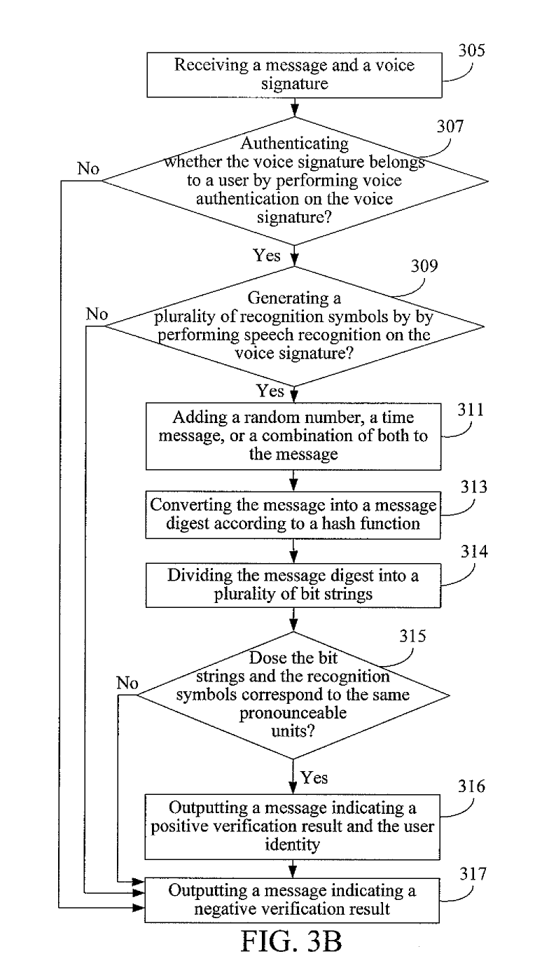

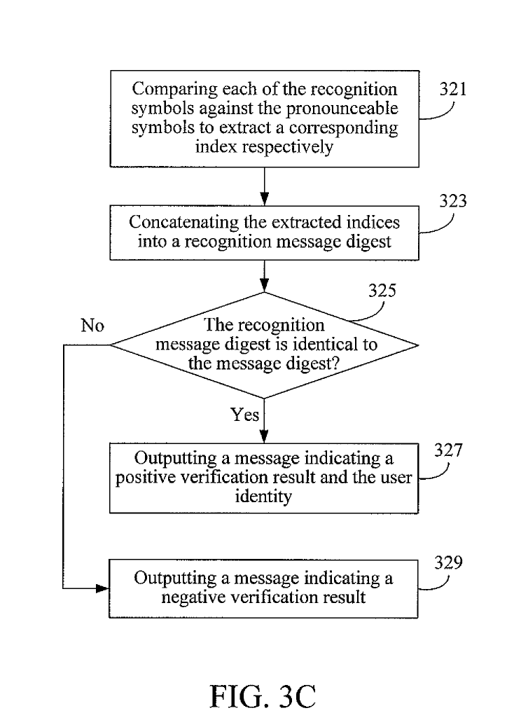

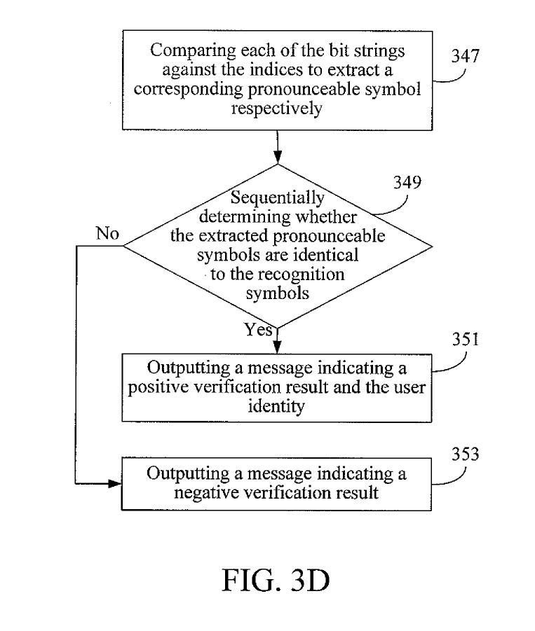

The third embodiment of this invention is a method for verifying a voice signature of a message, a flowchart of which is depicted in FIGS. 3A, 3B, 3C and 3D. More specifically, the method of the third embodiment determines whether the voice signature is indeed generated by the user for the message by verifying the user identity of the voice signature and verifying the correspondence relationship between the voice signature and the message. The method of the third embodiment must be used in combination with a voice database. Furthermore, the third embodiment and the second embodiment adopt respectively a generation method and a verification method that correspond to each other, and are both used in combination with a same set of pronounceable symbols.

The flowchart of a pre-process for the user to register his or her voice depicted in FIG. 3A will be described first. Initially, step 301a is executed to receive a set identity chosen by the user. Step 301b is executed to choose a set of pronounceable symbols from a plurality of suitable sets of pronounceable symbols according to the set identity. Each of the suitable sets has an identity, and the identity of the set of pronounceable symbols chosen in step 301b is identical to the set identity received in step 301a. Next, step 301c is executed to output a plurality of pronounceable symbols from the set, each of which is then uttered by the user to generate a registration acoustic wave respectively. The method of the third embodiment then proceeds to step 301d to receive the registration acoustic waves. Afterwards, step 301e is executed to convert each of the registration acoustic waves into a voice signal.

Next, step 301f is executed to generate a voice reference of the user according to the voice signals generated in step 301e. In particular, relevant voice processing such as voice feature extraction and acoustic modeling is performed on the voice signals to generate the voice reference of the user. Then, step 301g is executed to store the voice reference and the set identity previously chosen by the user into the voice database. Meanwhile, an identity of the user corresponding to the voice reference and the set identity is also stored.

It should be appreciated that, step 301a is provided for the user to choose a desired set of pronounceable symbols for use, while steps 301b, 301c, 301d, 301e, 301f and 301g are provided to register and record the voice reference of the user. For a single user, steps 301a-301g only need to be executed once. Once the user has chosen the set of pronounceable symbols through step 301a and has registered his or her voice reference through steps 301b-301g, steps of the second embodiment can be used to generate a voice signature for a message and it is no longer necessary to execute the aforesaid registration process when the voice signature of the user is verified in the third embodiment For an unregistered user, a voice signature thereof will fail the verification process.

Now, subsequent operations of the third embodiment will be explained with reference to FIG. 3B. In the third embodiment, step 305 is executed to receive a message and a voice signature generated by the method of the second embodiment. Subsequently, step 307 is executed to authenticate that the voice signature belongs to a user by performing voice authentication on the voice signature according to the voice database. In particular, if the second embodiment has generated the voice signature by assembling (concatenating) a plurality of voice features, then step 307 uses the voice features directly to compare to each of the voice references stored in the voice database for similarity matching. On the other hand, if the second embodiment has generated the voice signature by assembling (concatenating) the voice signals, then step 307 extracts a plurality of voice features from the voice signature first and then compares the voice features to each of the voice references stored in the voice database for similarity matching. No matter which of the two approaches is used, when a similarity is greater than a preset level, the identity corresponding to the voice reference with that similarity is determined as the user identity; i.e., step 307 gives a positive determination result. Otherwise, if step 307 gives a negative determination result, step 317 is executed to output a message indicating a negative verification result.

If step 307 gives a positive result, then step 309 is executed to generate a plurality of recognition symbols by performing speech recognition on the voice signature according to the voice database. In particular, step 309 compares the voice features of the voice signature to the voice reference of the user for recognition purposes, with the expectation of generating a plurality of recognition symbols each corresponding to one of the pronounceable symbols in the set of pronounceable symbols respectively. If the answer in step 309 is no (i.e. failing to recognize any recognition symbols), step 317 is executed to output a message indicating a negative verification result. Otherwise, if the answer in step 309 is yes, the process proceeds to step 311.

In step 311, a random number, time message, or the combination of both is added to the received message. It should be appreciated that, if step 201 is not executed in the second embodiment, step 311 will also be skipped in the third embodiment. Then, step 313 is executed to convert the message into a message digest according to a hash function. It should be appreciated that, steps 311 and 313 may also be executed prior to step 307 in other examples.

Next, step 314 is executed to divide the message digest into a plurality of bit strings. During the dividing process of step 314, it is determined whether the number of bits in the last bit string is smaller than a preset bit number. If the number of bits of the last bit string is smaller than the preset bit number, the last bit string is padded to the preset bit number with the same preset bit as that used in step 205. Then, step 315 is executed to verify if the voice signature is generated by the user for the message by determining whether the recognition symbols obtained in step 309 and the bit strings obtained in step 314 correspond to the same pronounceable units. If the recognition symbols and the indices corresponding to the bit strings correspond to the same pronounceable units, it means that the voice signature is indeed generated by the user for the message and the verification has concluded successfully. Then, step 316 is executed to output a message indicating a positive verification result and the user identity. Otherwise, the verification fails and step 317 is executed to output a message indicating a negative verification result.

The third embodiment also provides two alternative ways for verification. FIG. 3C depicts a flowchart of the first alternative way which makes the verification by comparing the message digest. The first alternative way for verification may replace the aforesaid steps 314 and 315. Initially, step 321 is executed to compare each of the recognition symbols obtained in step 309 to the pronounceable symbols in the set of pronounceable symbols to extract a corresponding index individually. Step 323 is executed to concatenate the extracted indices to form a recognition message digest. Thereafter, step 325 is executed to determine whether the recognition message digest is identical to the message digest generated in step 313. If so, step 327 is executed to output a message indicating a positive verification result and the user identity. Otherwise, the verification fails and step 329 is executed to output a message indicating a negative verification result.

Next, in the second alternative way, of which the verification is made by comparing pronounceable symbols will be described with reference to a flowchart depicted in FIG. 3D. The second alternative way for verification may replace the aforesaid steps 315. Initially, step 347 is executed to compare each of the bit strings generated in step 314 to the indices in the set of pronounceable symbols to extract a corresponding pronounceable symbol respectively. Then, step 323 is executed to sequentially determine whether each of the pronounceable symbols is identical to one of the recognition symbols generated in step 309. If the symbols are identical, step 351 is executed to output a message indicating a positive verification result and the user identity. Otherwise, the verification fails and step 353 is executed to output a message indicating a negative verification result.

In addition to the aforementioned steps and functions, the third embodiment can also execute all the operations and accomplish all the functions of the verification apparatus 13 described in the first embodiment. The method in which the third embodiment executes these operations and accomplishes these functions will be readily appreciated by those of ordinary skill in the art based on the explanation of the verification apparatus 13 of the first embodiment, and thus will not be further described herein.

The aforesaid methods may also be implemented as programs, and the programs can be stored on a computer readable medium. When the programs are loaded into a microprocessor, a plurality of codes are executed to enable the microprocessor to execute the steps of the second embodiment and the third embodiment. This computer readable medium may be a floppy disk, a hard disk, a compact disk, a mobile disk, a magnetic tape, a database accessible to networks, or any other storage media with the same function and well known to those skilled in the art.

According to this invention, both the generation end and the verification end use the same set of pronounceable symbols and a message is converted into a message digest of a shorter length according to a hash function. The message digest is further divided into a plurality of bit strings, according to which the pronounceable symbols can be extracted from the set of pronounceable symbols. Because the hash function may result in a conversion of approximately one-to-one correspondence, the converted message digest and the pronounceable symbols extracted from the bit strings are adequate to represent the message. Then, the generation end receives acoustic waves generated when the user utters the extracted pronounceable symbols and performs the processes described in the above embodiments on the acoustic waves to form a voice signature. Therefore, by incorporating the unique biometric voice features of the user to generate a signature (i.e. a voice signature), this invention prevents the theft of the secret key, unlike the case of the conventional PKI digital signature.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for generating a voice signature of a message, the method being used with a set of pronounceable symbols, the set of pronounceable symbols comprising a plurality of pronounceable units, each of the pronounceable units comprising an index and a pronounceable symbol, and the method comprising the steps of:
(a) converting the message into a message digest according to a hash function;
(b) generating a plurality of designated pronounceable symbols of the message digest according to the set of pronounceable symbols, each of the designated pronounceable symbols corresponding to one of the pronounceable symbols;
(c) receiving a plurality of pronunciation acoustic waves, each of the pronunciation acoustic waves being obtained from a user uttering one of the designated pronounceable symbols;
(d) converting each of the pronunciation acoustic waves into a voice signal individually; and
(e) generating the voice signature according to the voice signals.

2. The method of claim 1, wherein the step (e) generates the voice signature by concatenating the voice signals.

3. The method of claim 1, wherein the step (e) comprises the steps of:
extracting a voice feature from each of the voice signals; and
generating the voice signature by concatenating the voice features.

4. The method of claim 1, further comprising the step of:
outputting the designated pronounceable symbols prior to the step (c).

5. The method of claim 1, wherein the step (b) comprises the steps of:
dividing the message digest into a plurality of bit strings; and
comparing each of the bit strings to the indices to individually extract one of the designated pronounceable symbols.

6. The method of claim 1, further comprising the step of:
adding one of a random number, a time message, and a combination thereof to the message prior to the step (a);
wherein the hash function is a keyed hash function, the step (a) uses the keyed hash function and a preset key to convert the message into the message digest, and the preset key belongs to the user.

7. The method of claim 1, further comprising the step of:
adding one of a random number, a time message, and a combination thereof to the message prior to the step (a).

8. A method for verifying a voice signature of a message, the method being used with a voice database and a set of pronounceable symbols, the set of pronounceable symbols comprising a plurality of pronounceable units, each of the pronounceable units comprising an index and a pronounceable symbol, the method comprising the steps of:
(a) authenticating that the voice signature belongs to a user by performing voice authentication on the voice signature according to the voice database;
(b) generating a plurality of recognition symbols by performing speech recognition on the voice signature according to the voice database, each of the recognition symbols corresponding to one of the pronounceable symbols;
(c) converting the message into a message digest according to a hash function, the message digest comprising a plurality of bit strings, each of the bit strings corresponding to one of the indices; and
(d) verifying that the user has generated the voice signature for the message by determining that the recognition symbols and the corresponding indices correspond to the same pronounceable units.

9. The method of claim 8, wherein the step (d) comprises the steps of:
(d1) comparing each of the recognition symbols to the pronounceable symbols to individually extract the corresponding index;
(d2) generating a recognition message digest by concatenating the extracted indices; and
(d3) verifying that the user has generated the voice signature for the message by determining that the recognition message digest is identical to the message digest.

10. The method of claim 8, wherein the step (d) comprises the steps of:
(d1) generating a plurality of designated pronounceable symbols of the message digest according to the set of pronounceable symbols, each of the designated pronounceable symbols corresponding to one of the pronounceable symbols; and
(d2) verifying that the user has generated the voice signature for the message by sequentially determining that the designated pronounceable symbols are identical to the recognition symbols.

11. The method of claim 10, wherein the step (d1) comprises the steps of:
dividing the message digest into a plurality of bit strings; and
comparing each of the bit strings to the indices to extract a corresponding designated pronounceable symbols respectively.

12. The method of claim 8, further comprising the step of:
adding one of a random number, a time message, and a combination thereof to the message prior to the step (c);
wherein the hash function is a keyed hash function, the step (c) uses the keyed hash function and a preset key to convert the message into the message digest, and the preset key belongs to the user.

13. The method of claim 8, further comprising the step of:
adding one of a random number, a time message, and a combination thereof to the message prior to the step (c).

14. The method of claim 8, further comprising the following.steps prior to the step (a):
receiving a plurality of registration acoustic waves, each of the registration acoustic waves being obtained from the user uttering one of the pronounceable symbols;
converting each of the registration acoustic waves into a voice signal individually;
generating a voice reference of the user according to the voice signals; and
storing the voice reference and an identity of the user into the voice database.

15. The method of claim 8, further comprising the following steps prior to the step (a):
(e) receiving a set identity; and
(f) choosing the set of pronounceable symbols from a plurality of suitable sets of pronounceable symbols according to the set identity;
wherein each of the suitable sets of pronounceable symbols has an identity, and the identity of the set of pronounceable symbols chosen in the step (f) is identical to the set identity.

16. The method of claim 14, wherein the voice signature comprises a plurality of voice features, the step (a) ascertains that the voice signature belongs to the user by determining that a similarity level between the voice features and the voice reference is greater than a preset level, and the step (b) generates the recognition symbols by comparing the voice features to the voice reference.

17. The method of claim 14, further comprising the step of:
extracting a plurality of voice features from the voice signature;
wherein the step (a) ascertains that the voice signature belongs to the user by determining that a similarity level between the voice features and the voice reference is greater than a preset level, and the step (b) generates the recognition symbols by comparing the voice features against the voice reference.

18. An apparatus for generating a voice signature of a message, comprising:
a storage module, being configured to store a set of pronounceable symbols, the set of pronounceable symbols comprising a plurality of pronounceable units, each of the pronounceable units comprising an index and a pronounceable symbol;
a process module, being configured to convert the message into a message digest according to a hash function and generate a plurality of designated pronounceable symbols of the message digest according to the set of pronounceable symbols, each of the designated pronounceable symbols corresponding to one of the pronounceable symbols; and
a receive module, being configured to receive a plurality of pronunciation acoustic waves, each of the pronunciation acoustic waves being obtained from a user uttering one of the designated pronounceable symbols and being configured to convert each of the pronunciation acoustic waves into a voice signal individually;
wherein the process module is further configured to generate the voice signature according to the voice signals.

19. The apparatus of claim 18, wherein the process module is configured to generates the voice signature by concatenating the voice signals.

20. The apparatus of claim is, wherein the process module is configured to extract a voice feature from each of the voice signals and generates the voice signature by concatenating the voice features.

21. The apparatus of claim 18, further comprising:
an output module, being configured to output the designated pronounceable symbols;
wherein the receive module is configured to receive the pronunciation acoustic waves after the output module has outputted the extracted pronounceable symbols.

22. The apparatus of claim 18, wherein the process module is configured to divide the message digest into a plurality of bit strings and compare each of the bit strings to the indices to individually extract one of the designated pronounceable symbols.

23. The apparatus of claim 18, wherein the hash function is a keyed hash function, the process module is configured to use the keyed hash function and a preset key to convert the message into the message digest, the preset key belongs to the user, and the process module is further configured to add one of a random number, a time message, and a combination thereof to the message before converting the message into the message digest.

24. The apparatus of claim 18, wherein the process module is further configured to add one of a random number. a time message, and a combination thereof to the message before converting the message into the message digest.

25. An apparatus for verifying a voice signature of a message, the apparatus being used with a voice database and comprising:
a storage module, being configured to store a set of pronounceable symbols, the set of pronounceable symbols comprising a plurality of pronounceable units, each of the pronounceable units comprising an index and a pronounceable symbol;
a voice module, being configured to authenticating that the voice signature belongs to a user by performing voice authentication on the voice signature according to the voice database and generating a plurality of recognition symbols by performing speech recognition on the voice signature according to the voice database, each of the recognition symbols corresponding to one of the pronounceable symbols; and
a process module, being configured to convert the message into a message digest according to a hash function, the message digest comprising a plurality of bit strings, each of the bit strings corresponding to one of the indices and being configured to verify that the user has generated the voice signature for the message by determining that the recognition symbols and the corresponding indices correspond to the same pronounceable units.

26. The apparatus of claim 25, wherein the process module is configured to compare each of the recognition symbols to the pronounceable symbols to individually extract the corresponding index, generate a recognition message digest by concatenating the extracted indices, and verity that the user has generated the voice signature for the message by determining that the recognition message digest is identical to the message digest.

27. The apparatus of claim 25, wherein the process module is further configured to generate a plurality of designated pronounceable symbols of the message digest according to the set of pronounceable symbols, each of the designated pronounceable symbols corresponds to one of the pronounceable symbols, and the process module is further configured to verify that the user has generated the voice signature for the message by sequentially determining that the designated pronounceable symbols are identical to the recognition symbols.

28. The apparatus of claim 27, wherein the process module is configured to divide the message digest into a plurality of bit strings and compare each of the bit strings to the indices to extract a corresponding designated pronounceable symbols.

29. The apparatus of claim 25, wherein the hash function is a keyed hash function, the process module is configured to use the keyed hash function and a preset key to convert the message into the message digest, the preset key belongs to the user, and the process module is further configured to add one of a random number, a time message, and a combination thereof to the message before converting the message.

30. The apparatus of claim 25, wherein the process module is further configured to add one of a random number, a time message, and a combination thereof to the message before converting the message.

31. The apparatus of claim 25, further comprising:
a receive module, being configured to receive a plurality of registration acoustic waves, each of the registration acoustic waves being obtained from the user uttering one of the pronounceable symbols and being configured to convert each of the registration acoustic waves into a voice signal individually; and
a write module;
wherein the voice module is further configured to generate a voice reference of the user according to the voice signals and the write module is configured to store the voice reference and an identity of the user into the voice database.

32. The apparatus of claim 25, wherein the receive module is further configured to receive a set identity, and the process module is further configured to choose the set of pronounceable symbols from a plurality of suitable sets of pronounceable symbols according to the set identity, wherein each of the suitable sets of pronounceable symbols has an identity and the identity of the set of pronounceable symbols chosen by the process module is identical to the set identity.

33. The apparatus of claim 31, wherein the voice signature comprises a plurality of voice features, the voice module is configured to ascertain that the voice signature belongs to the user by determining that a similarity level between the voice features and the voice reference is greater than a preset level, and the voice module is configured to generate the recognition symbols by comparing the voice features to the voice reference.

34. The apparatus of claim 31, wherein the voice module is further configured to extract a plurality of voice features from the voice signature, ascertain that the voice signature belongs to the user by determining that a similarity level between the voice features and the voice reference is greater than a preset level, and generate the recognition symbols by comparing the voice features to the voice reference.

35. A computer readable medium storing a program for enabling a microprocessor to generate a voice signature of a message, the program being used with a set of pronounceable symbols, the set of pronounceable symbols comprising a plurality of pronounceable units, each of the pronounceable units comprising an index and a pronounceable symbol, the program comprising:
code A for enabling the microprocessor to convert the message into a message digest according to a hash function;
code B for enabling the microprocessor to generate a plurality of designated pronounceable symbols of the message digest according to the set of pronounceable symbols, each of the designated pronounceable symbols corresponding to one of the pronounceable symbols;
code C for enabling the microprocessor to receive a plurality of pronunciation acoustic waves, each of the pronunciation acoustic waves being obtained from a user uttering one of the designated pronounceable symbols;
code D for enabling the microprocessor to convert each of the pronunciation acoustic waves into a voice signal individually; and
code E for enabling the microprocessor to generate the voice signature according to the voice signals.

36. The computer readable medium of claim 35, wherein the code E comprises:
code E1 for enabling the microprocessor to extract a voice feature from each of the voice signals; and
code E2 for enabling the microprocessor to generate the voice signature by concatenating the voice features.

37. The computer readable medium of claim 35, wherein the code B comprises:
code B1 for enabling the microprocessor to divide the message digest into a plurality of bit strings; and
code B2 for enabling the microprocessor to compare each of the bit strings to the indices to individually extract one of the designated pronounceable symbols.

38. A computer readable medium storing a program for enabling a microprocessor to verify a voice signature of a message, the program being used with a voice database and a set of pronounceable symbols, the set of pronounceable symbols comprising a plurality of pronounceable units, each of the pronounceable units comprising an index and a pronounceable symbol, the program comprising:
code A for enabling the microprocessor to authenticate that the voice signature belongs to a user by performing voice authentication on the voice signature according to the voice database;
code B for enabling the microprocessor to generating a plurality of recognition symbols by performing speech recognition on the voice signature according to the voice database, each of the recognition symbols corresponding to one of the pronounceable symbols;
code C for enabling the microprocessor to convert the message into a message digest according to a hash function, the message digest comprising a plurality of bit strings, each of the bit strings corresponding to one of the indices; and
code D for enabling the microprocessor to verify that the user has generated the voice signature for the message by determining that the recognition symbols and the corresponding indices correspond to the same pronounceable units.

39. The computer readable medium of claim 38, wherein the code D comprises:
code D1 for enabling the microprocessor to compare each of the recognition symbols to the pronounceable symbols to individually extract the corresponding index;
code D2 for enabling the microprocessor to concatenate the extracted indices into a recognition message digest; and
code D3 for enabling the microprocessor to verify that the user has generated the voice signature for the message by determining that the recognition message digest is identical to the message digest.

40. The computer readable medium of claim 38, wherein the code D comprises:
code D1 for enabling the microprocessor to generate a plurality of designated pronounceable symbols of the message digest according to the set of pronounceable symbols, each of the designated pronounceable symbols corresponding to one of the pronounceable symbols; and
code D2 for enabling the microprocessor to verify that the user has generated the voice signature for the message by sequentially determining that the extracted pronounceable symbols are identical to the recognition symbols.

41. The computer readable medium of claim 40, wherein the code D1 further enables the microprocessor to divide the message digest into a plurality of bit strings and compare each of the bit strings to the indices to extract a corresponding designated pronounceable symbols respectively.

42. The computer readable medium of claim 38, wherein the program further comprises:
code E for enabling the microprocessor to receive a set identity; and
code F for enabling the microprocessor to choose the set of pronounceable symbols from a plurality of suitable sets of pronounceable symbols according to the set identity;
wherein each of the suitable sets of pronounceable symbols has an identity, and the identity of the set of pronounceable symbols chosen by the microprocessor is identical to the set identity.
